(19) United States
(12) Patent Application Publication
(10) Pub. No.: US 2015/0219269 A1
(43) Pub. Date: Aug. 6, 2015

(54) THERMAL INSULATION WITH FUNCTIONAL GRADIENT AND INORGANIC AEROGEL LAYER

(71) Applicant: Lockheed Martin Corporation, Bethesda, MD (US)

(72) Inventors: Corey A. Fleischer, Abingdon, MD (US); David C. Briggs, Edgewood, MD (US); Linda M. Pelullo, Blackwood, NJ (US); James A. Waicukauski, Bel Air, MD (US)

(73) Assignee: Lockheed Martin Corporation, Bethesda, MD (US)

(21) Appl. No.: 14/611,082

(22) Filed: Jan. 30, 2015

Related U.S. Application Data
(60) Provisional application No. 61/934,682, filed on Jan. 31, 2014.

(51) Int. Cl. F16L 59/02; B32B 5/32; B32B 19/04; B63B 3/14; B32B 5/24

(52) U.S. Cl. CPC F16L 59/026; B63B 3/14; B32B 5/245; B32B 19/047; B32B 5/32; B32B 2262/108; B32B 2262/101; B32B 2266/04; B32B 2307/304; B32B 2605/12

(57) ABSTRACT

According to some aspects, a thermal insulation material is provided, comprising a first insulation layer comprising an aerogel, and a second insulation layer comprising inorganic fibers, wherein a thickness of the second insulation layer is greater than a thickness of the first insulation layer. According to some aspects, a fire protection thermal insulation system is provided, comprising a first insulation layer comprising an aerogel, the first insulation layer on a fire facing side of the thermal insulation system, and a second insulation layer comprising inorganic fibers, the second insulation layer on a non-fire facing side of the thermal insulation system, wherein a thickness of the second insulation layer is greater than a thickness of the first insulation layer.

### CROSS-REFERENCE TO RELATED APPLICATIONS

The present application claims the benefit under 35 U.S.C. §119(e) of U.S. Provisional Patent Application No. 61/934,682, filed Jan. 31, 2014, titled “Thermal Insulation With Functional Gradient And Inorganic Aerogel Layer,” which is hereby incorporated by reference in its entirety.

### BACKGROUND

Passive fire protection is often provided in buildings, vehicles and marine vessels by the use of mineral wool. Mineral wool (also sometimes referred to as mineral fiber, stone wool, alkali earth, man-made mineral fiber or man-made vitreous fiber) is a fiber material formed by spinning and/or drawing molten minerals (or so-called “synthetic minerals” such as slag or ceramics). Mineral wool is frequently used because it has the characteristics of flexibility and durability at high temperatures, while retaining thermal insulation properties. Mineral wool insulation is often made and installed in a layer having a thickness that is determined based on desired thermal insulation properties.

### SUMMARY

This invention relates to high-temperature passive thermal insulation, specifically, thermally-insulating flexible blankets.

According to some aspects, a thermal insulation material is provided, the thermal insulation material comprising a first insulation layer comprising an aerogel, and a second insulation layer comprising inorganic fibers, wherein a thickness of the second insulation layer is greater than a thickness of the first insulation layer.

According to some aspects, a thermal insulation material is provided, the thermal insulation material comprising a first insulation layer comprising an alumino-silicate aerogel, and a second insulation layer comprising inorganic fibers.

According to some aspects, a fire protection thermal insulation system is provided, the fire protection thermal insulation system comprising a first insulation layer comprising an aerogel, the first insulation layer on a fire facing side of the thermal insulation system, and a second insulation layer comprising inorganic fibers, the second insulation layer on a non-fire facing side of the thermal insulation system, wherein a thickness of the second insulation layer is greater than a thickness of the first insulation layer.

According to some aspects, a method of providing fire insulation within an marine vessel is provided, the method comprising attaching a thermal insulation material to one or more structures of the marine vessel, wherein the thermal insulation material comprises a first insulation layer comprising an aerogel, the first insulation layer on a side of the thermal insulation material distal to the one or more structures, and a second insulation layer comprising inorganic fibers, the second insulation layer on a side of the thermal insulation material proximal to the one or more structures, wherein a thickness of the second insulation layer is greater than a thickness of the first insulation layer.

### BRIEF DESCRIPTION OF DRAWINGS

Various aspects and embodiments will be described with reference to the following figures. It should be appreciated that the figures are not necessarily drawn to scale. In the drawings, each identical or nearly identical component that is illustrated in various figures is represented by a like numeral. For purposes of clarity, not every component may be labeled in every drawing.

FIG. 1 is a photograph of mineral wool batting installed upon the steel hull of a vessel;

FIG. 2 is a cross-sectional view of fire protection insulation made from mineral wool;

FIG. 3 is an illustrative chart depicting the thermal conductivity of two materials as a function of temperature, according to some embodiments;

FIG. 4 is a cross-sectional view of fire protection insulation, according to some embodiments;

FIG. 5 is a chart depicting temperature gradients of three illustrative fire insulation systems, according to some embodiments;

FIG. 6 is a photograph of a illustrative thermally-insulating blanket, in accordance with some embodiments; and

FIG. 7 depicts an exploded view of an illustrative fire insulation material, according to some embodiments.

### DETAILED DESCRIPTION

In the event of a fire, one side of fire protection insulation is typically facing, or in proximity to, the heat of the fire. This results in a temperature gradient across the insulation where the temperature is at, or close to, that of the fire on one side of the insulation and a lower temperature on the other side of the insulation. The more effective the insulation, the lower the temperature on the non-facing or non-fire proximate side of the insulation. If the temperature on the non-fire facing side of the insulation is sufficiently high, damage to a structure or other object may result from the heat of the fire propagating through the insulation. For a hydrocarbon fire, temperatures to which the insulation is exposed can rise up to 1000° C. on the side facing, or in proximity to, the fire, but the desired temperature on the opposing side (i.e., that which would avoid or mitigate structural damage) may be much lower, such as around 100-200° C.

Passive fire insulation, such as in walls or other structures, may be provided using one or more layers of mineral wool or mineral fiber batting (sometimes referred to as “blankets”). Mineral wool blanket insulation is often used for its high temperature resistance, flexible product form, and non-toxic qualities, as well as its low cost. U.S. Navy vessels utilize fire protection insulation so as to be conformant with the organization's MIL-PRF-32161 high temperature fire protection specification, which are typically met by multiple layers of mineral wool. Ordinarily, such fiber batting is installed throughout a vessel to protect the vessel against damage from fires.

Generally speaking, there are two types of fires that a fire boundary within a marine vessel may be designed to stop. One is a hydrocarbon pool fire, which is characterized by a rapid temperature rise to around 1100° C., and a second is a cellulose fire, characterized by a rapid temperature rise to around 500° C., followed by a comparatively slow temperature rise to 1100° C. A majority of fire boundary insulations use mineral wool due to good performance at a reasonable cost, especially at lower temperatures. At the higher temperatures of a hydrocarbon pool fire, mineral wool is less efficient than at lower temperature due to its structure's relatively large mean free path, which allows air molecules to convect heat at these temperatures. Typically, twice the thickness of mineral wool is required to meet fire boundary requirements for a hydrocarbon pool fire versus a cellulose fire. In a large Navy combatant vessel, where there are many fire boundaries for which regulations require resistance to hydrocarbon pool fires, there is typically over 100 tons of fire boundary insulation. There is therefore a significant weight savings opportunity if fire boundary insulation could affordably be made more efficient at insulating against a high temperature hydrocarbon pool fire, since this might reduce the total weight of the fire boundary insulation necessary to protect against such fires.

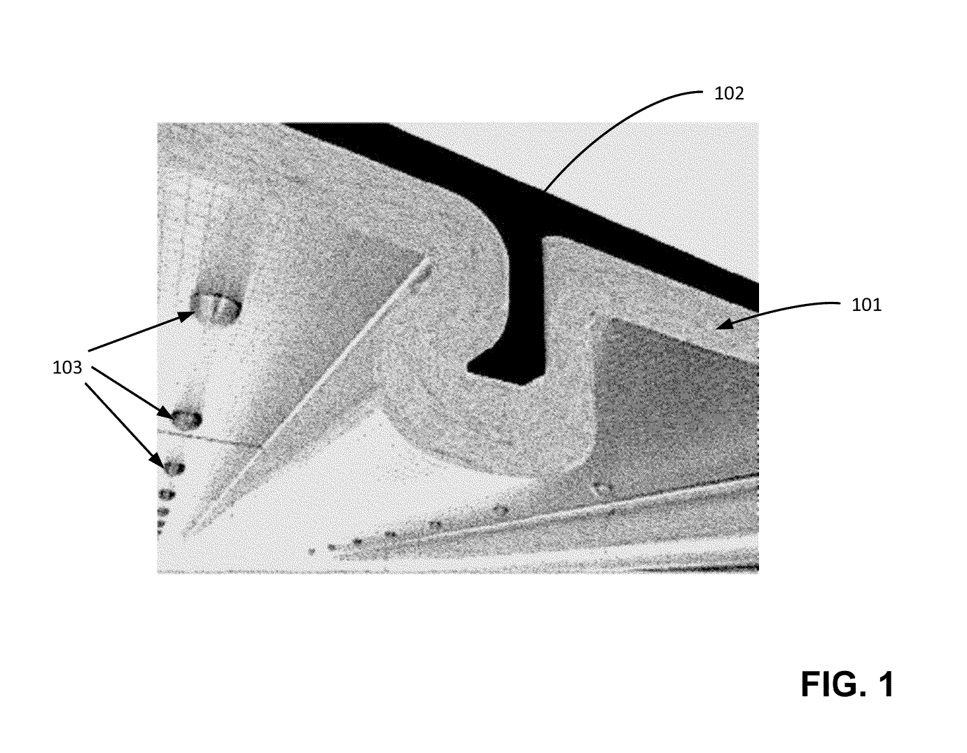

FIG. 1 is an illustration of mineral wool batting installed within the steel hull of a Naval vessel. FIG. 1 illustrates a cross-section through the hull of the vessel, depicting mineral wool insulation 101 through a section of the vessel. In the example of FIG. 1, insulation 101 comprises several layers of mineral wool batting that together have a combined thickness of several inches. The insulation 101 is wrapped around a steel beam 102 and attached via pins 103. The insulation 101 includes a surface layer, such as fiberglass cloth (not labeled), that prevents people or objects that might come into contact with the insulation from causing abrasion of the mineral wool, and to provide containment of the mineral wool.

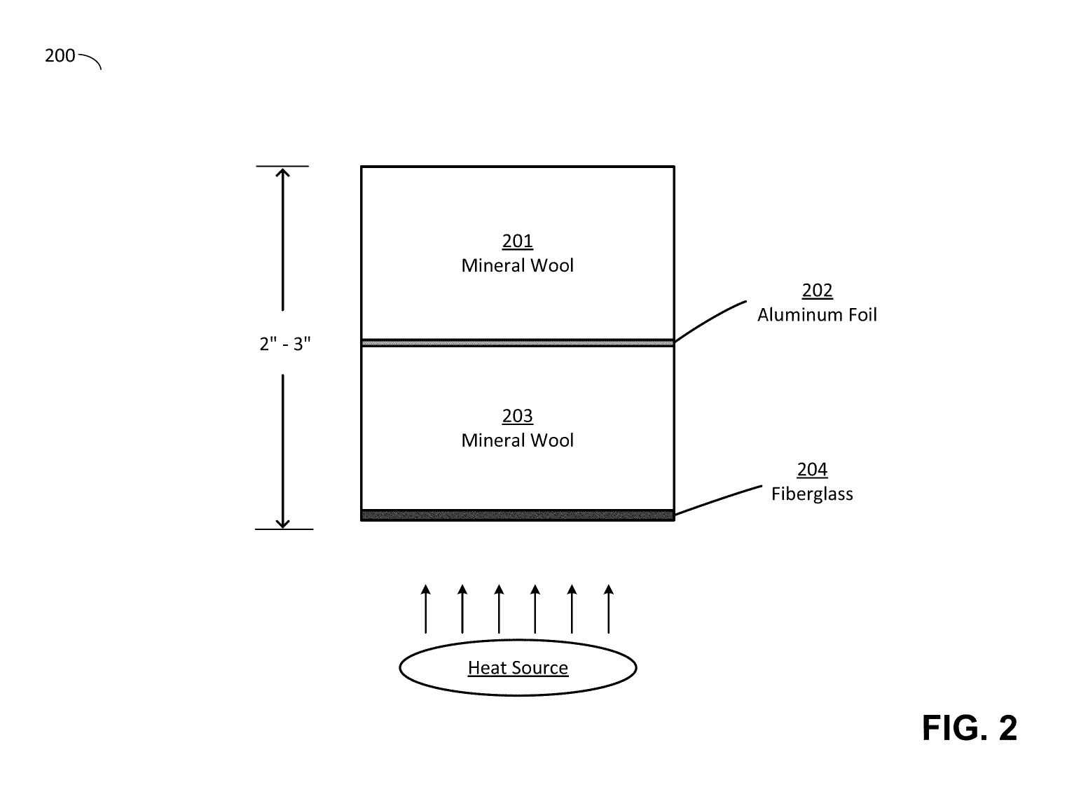

FIG. 2 is a cross-sectional view of a thermal insulation solution 200 that comprises multiple layers of mineral wool. Two equally thick layers of mineral wool 201 and 203 are separated by a layer of aluminum foil 202, which provides infrared reflectivity to reflect heat that is transmitted from the heat source through mineral wool layer 203. Typically the mineral wool has a density on the order of 6 to 8 lb/ft³. On the side of the insulation facing the heat source, a thin layer of fiberglass cloth 204 (e.g., E-glass) is deployed to provide containment of the mineral wool layer 203. The combined thickness of mineral wool that is needed to provide the necessary fire protection (e.g., the MIL-PRF-32161 specification in a U.S. Naval vessel) is between 2″ and 3″, which depends on the type of application. For example, to meet the MIL-PRF-32161 fire protection specification, the insulation solution 200 has a thickness of roughly 2″ when used for steel structure protection, and a thickness of 3″ when used for aluminum structure protection.

The inventors have recognized and appreciated that, particularly on marine vessels where space and weight are at a premium, it is desirable to reduce bulk and weight of fire protection insulation. For example, on a U.S. Navy 3,500 metric ton vessel, there may be over 60 metric tons of mineral wool blanket insulation present on board. While mineral wool blanket insulation is low cost and flexible, it also therefore represents a substantial weight component of a vessel, which may reduce the vessel's performance (e.g., the vessel's speed and range). The inventors have recognized and appreciated that a lightweight, thin insulation solution may provide a substantial performance increase for a vessel by reducing the amount of weight needed for fire protection insulation while still meeting fire protection goals (e.g., the MIL-PRF-32161 specification).

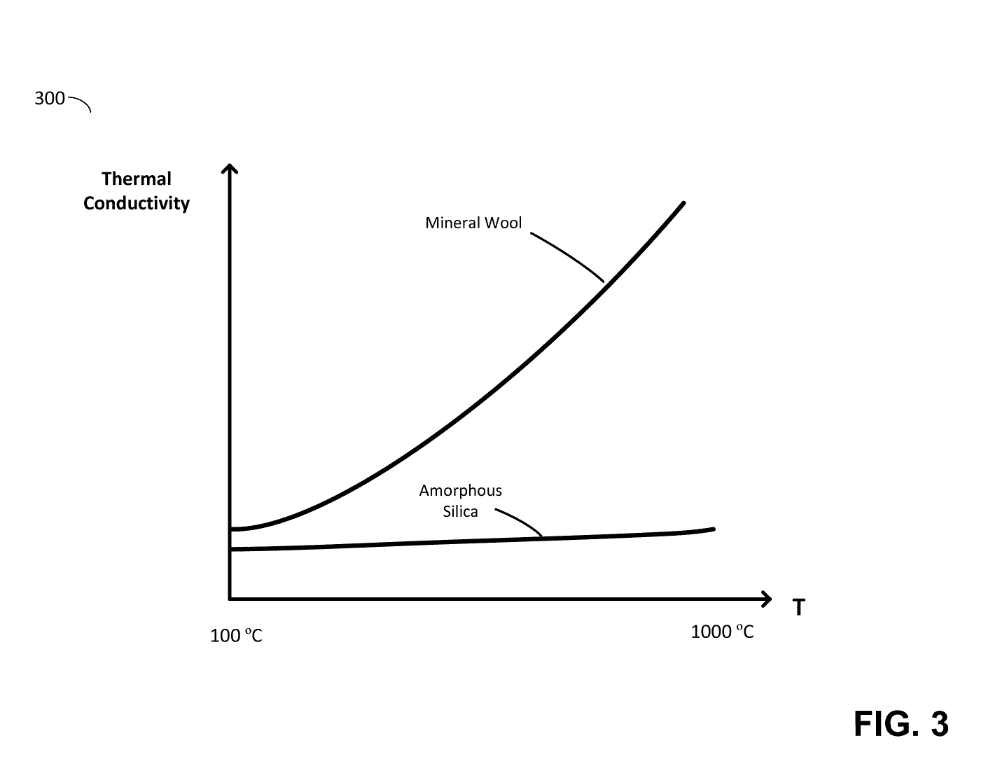

While some materials that provide greater fire protection than mineral wool are available, they are also significantly more costly than mineral wool and generally more difficult to work with during installation into a marine vessel. However, the inventors have recognized and appreciated that an effective fire insulation may be formed by combining two different insulating materials that together produce an effective fire protection temperature gradient while simultaneously reducing bulk and weight of the insulation. The temperature gradient across a layer of material depends upon the temperature at both sides of the layer and on the material's thermal conductivity (which generally changes significantly as a function of temperature). The inventors have recognized that providing material with a low thermal conductivity (e.g., at comparatively high temperatures) on a fire facing side of the insulation reduces the need for a material with such a low thermal conductivity on a non-fire facing side of the insulation. Generally, thermal conductivity increases with increasing temperature. However, different materials generally have thermal conductivities that increase at different rates. This means that the difference between the thermal conductivities of two different materials generally becomes larger as temperature increases. As an example, FIG. 3 qualitatively illustrates the thermal conductivity of two materials, mineral wool and amorphous silica, as a function of temperature. As shown, the difference in thermal conductivities of the two materials becomes smaller as the temperature decreases.

The inventors have appreciated that, since a layer of a first material having a low thermal conductivity at comparatively high temperatures (e.g., amorphous silica) may reduce the temperature substantially across its thickness (e.g., from 1000° C. to 500° C.), this may reduce the temperature such that the difference in thermal conductivities of the first material and a second material at this reduced temperature may be less than the difference in their thermal conductivities at the higher, exterior temperature. Thus, the second material may become a suitable choice for the remainder of the insulation, especially if it is less costly than the first material. In the example of FIG. 3, for instance, a layer of amorphous silica may be used to reduce the temperature from 1000° C. to 500° C., at which point the thermal conductivities of the amorphous silica and mineral wool are more similar than they were at 1000° C. Accordingly, a remainder of the insulation may be made from a layer of mineral wool, which will provide comparable performance to using pure amorphous silica, yet may provide other benefits such as reduced cost and/or increase ease of production. Therefore, while the second (non-fire facing) material may be less effective at fire insulation per unit weight and/or volume than the first (fire facing) material, by using the first material to reduce the temperature part-way from the initial (e.g., fire) temperature to the desired temperature, the second material may nevertheless be a suitable choice to maximize the cost versus benefit of the insulation because at the reduced temperature the difference in fire insulation effectiveness between the two materials may be far less than the difference in fire insulation effectiveness at the initial temperature.

The inventors have recognized that inorganic aerogels are a particularly good candidate for use as a fire facing layer of fire protection insulation because of their low weight, low density, and low thermal conductivity at high temperatures (e.g., above 500° C.). Such properties are in part due to aerogels having an open-cell, inorganic nano-porous cellular structure, such that these materials are mostly open space due to their structure, and are known to be among the least dense solid materials known. Moreover, the inventors have recognized that alumino-silicate aerogels may be easier to handle during a manufacturing process for a fire insulation comprising an aerogel due to, for example, no powder (e.g. fumed silica) being necessary during the process.

As used herein, the term “aerogel” includes both a pure aerogel and a pure aerogel provided on a carrier material. Carrier materials may include any suitable fibrous or macro-porous strength material, including but not limited to, fiberglass cloth, ceramic felt, mineral wool, organic, inorganic or metallic sponge, pumice or combinations thereof.

According to some embodiments, a layer of aerogel may be combined with a layer of mineral wool to form fire protection insulation that has a reduced bulk and weight compared to a monolithic mineral wool insulation yet having commensurate fire protection properties. In particular, by configuring the insulation such that the aerogel layer faces a heat source, the temperature gradient across that layer may be such that the layer of mineral wool, which does not face the heat source, experiences a lower temperature at which its thermal conductivity is more similar to that of the aerogel. While an aerogel generally has lower thermal conductivity than a mineral wool and is lighter, it is also much more costly. However, the inventors have recognized that by combining suitable thicknesses of an aerogel layer with an inorganic fiber layer, such as mineral wool, fire insulation may be produced that is almost as light as a pure aerogel insulation having the same fire insulation effectiveness, yet is several times less costly to produce.

According to some embodiments, an aerogel may be selected to provide desired temperature insulation and thermal stability properties at particular temperatures. For example, the thermal stability of a typical silica aerogel starts to degrade around 600-700° C. as a result of the microcellular structure degrading due to sintering, and the pockets of air trapped within may begin to collapse. However, at these temperatures, alumino-silicate aerogels generally retain their nano-porous structure, and may continue to provide thermal protection up to temperatures of around 1000° C. For example, an alumino-silicate aerogel may exhibit a thermal resistivity that is six to ten times greater than an equivalent thickness of mineral wool at temperatures in the 600° C. to 1000° C. range. According to some embodiments, therefore, a fire facing layer of an alumino-silicate aerogel may be used in a fire insulation material.

According to some embodiments, an aerogel layer may have layers and/or sub-layers to promote flexibility of a fire insulation material. In some cases, when an aerogel is cured in a fiber substrate, the fiber makes the aerogel stiffer than the pure aerogel might otherwise be. According to some embodiments, an aerogel layer may comprise multiple distinct layers of an aerogel which can slide relative to one another, thereby enhancing flexibility of the fire insulation material.

According to some embodiments, one or more reflectors may be provided between any number of material layers of a fire insulation material, including the exterior surface of the material. Heat is transferred by conduction, by convection, and/or by radiation. Aerogels and associated substrates on which they may be manufactured typically have a circuitous solid pathway and therefore their conduction of heat tends to be comparatively low. Also, since the pores/channels of the aerogel are smaller than the mean free path of air molecules, circulation of air is inhibited through the aerogel, thereby limiting heat transfer via convection of air. However, heat may also be transferred through an aerogel by radiation. The inventors have recognized that radiative heat transfer, which may therefore represent the primary mode of heat transfer within an aerogel, may be prevented or limited by adding an reflector, such as a layer of foil or dispersing TiO₂ in one or more of the layers to reflect radiative heat through the aerogel and thereby provide a high level of temperature insulation. In some cases, a multiple reflector layers may be included between any layers (e.g., multiple reflector layers may be stacked between two insulator layers and/or reflector layers may be located between multiple pairs of adjacent layers) and/or at a surface of the insulator.

According to some embodiments, more than two layers of insulating material may be used in fire insulation. Three or more layers could be used, in some embodiments, which may include a layer of alumino-silicate aerogel, a layer of an inorganic fiber (e.g., mineral wool), a layer of silica aerogel, and/or a layer of polyimide foam. Additional layers and materials of those layers may be selected on the basis of their functional properties. As discussed above, a functional temperature gradient may be established by ordering the layers such that the material with lower thermal conductivity at high temperatures is nearer the source of heat. According to some embodiments, multiple layers of suitable materials (e.g., aerogels) having different pore sizes may be used in fire insulation, such as by arranging those layers to have increasing pore size with increasing distance from the fire facing side of the insulation. Such layers may comprise the same or different materials, including different aerogels (e.g., an alumino-silicate aerogel layer, a silica aerogel layer, etc. and with one or more reflective layers, if any, in between the layers).

According to some embodiments, a fire insulation may comprise multiple crimped layers in conjunction with an aerogel layer. The crimped layers may improve heat reflectivity and may increase the bending capability of the aerogel layer. In some cases, the crimped layers may include aluminum separators.

Following below are more detailed descriptions of various concepts related to, and embodiments of, thermal insulation that includes two different insulating materials that together provide an effective fire protection temperature gradient while reducing bulk and weight of the insulation. It should be appreciated that various aspects described herein may be implemented in any of numerous ways. Examples of specific implementations are provided herein for illustrative purposes only. In addition, the various aspects described in the embodiments below may be used alone or in any combination, and are not limited to the combinations explicitly described herein.

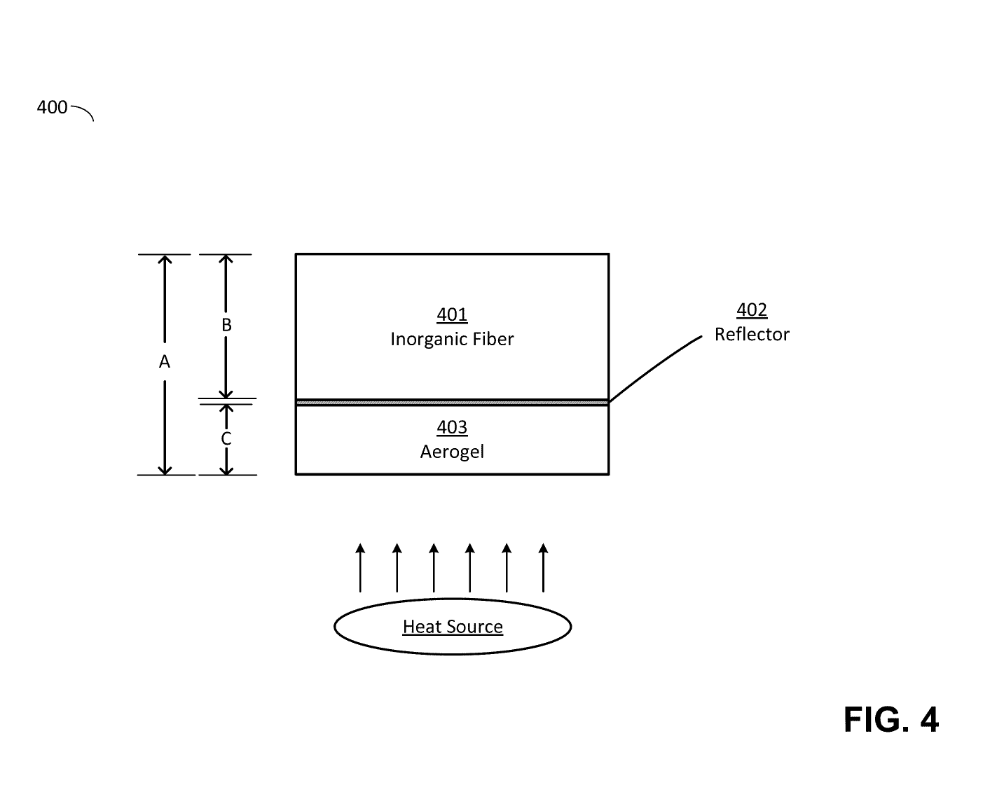

FIG. 4 is a cross-sectional view of thermal insulation, in accordance with some embodiments. Insulation 400 includes a layer of inorganic fibers 401 and a layer of an aerogel 403 in addition to reflector 402 between the two layers. As discussed above, such a configuration may provide fire protection commensurate with the thermal insulation solution 200 shown in FIG. 2 yet having a reduced weight and thickness.

Inorganic fiber 401 may comprise mineral wool or any other suitable layer of inorganic fibers. In the example of FIG. 4, the thickness B of layer 401 may be between 0.5″ and 1.5″, though more preferably is between 0.6″ and 1″, such as 0.75″. Aerogel layer 403 may comprise any suitable aerogels, including an amorphous silica aerogel, an alumino-silica aerogel, etc. The thickness C of layer 403 in the example of FIG. 4 may be between 0.1″ and 1″, though more preferably is between 0.25″ and 0.75″, or between 0.25″ and 0.5″, such as 0.3″. Reflector layer 402 includes any suitable layer that provides reflection of radiation incident from the side of the reflector facing the heat source, and may have any suitable thickness. According to some embodiments, reflector layer 402 comprises one or more layers of aluminum foil having a total thickness of less than 0.1″. The total thickness of the insulation A may be between 0.75″ and 2″, such as between 0.8″ and 1.5″, such as between 0.9″ and 1.2″, or such as 1.1″. According to some embodiments, the thickness C of layer 403 may be less than half of the thickness B of layer 401 while the absolute thicknesses may have any suitable value given this constraint. According to some embodiments, the thickness C of layer 403 may be less than one third of the thickness B of layer 401.

In some cases, an additional layer (not shown in the figure) may be provided on the side of the aerogel layer facing toward the heat source to provide structural containment and/or abrasion resistance. Such a layer may comprise, for example, quartz cloth and/or fiberglass cloth. Quartz cloth has a higher melting point than fiberglass, but provides containment commensurate to that of a fiberglass cloth. According to some embodiments, a hybrid cloth that includes both quartz yarn and fiberglass yarn may be employed as a surface fire facing layer. Such a hybrid may provide a higher pre-fire breaking strength and a lower post-fire breaking strength than a pure fiberglass cloth surface layer, yet may have a cost that is commensurate with a pure fiberglass cloth. In some use cases, such a hybrid cloth may include more fiberglass fibers than quartz fibers. In some use cases, a hybrid cloth may include fiberglass yarn, quartz yarn and one or more additional inorganic yarns. Irrespective of the content of a cloth surface layer, the cloth layer may be configured to be a three-dimensional weave that encapsulates all or part of the aerogel layer.

According to some embodiments, an additional reflector layer may be placed between the aerogel layer 403 and a containment layer or may be placed in lieu of a fibrous containment layer. As discussed above, in general any number of reflector layers may be used in a fire insulation as described herein.

In some use cases, insulation 400 may have a combined thickness A of 1.1″, which is significantly less than the 2″-3″ necessary to produce commensurate fire insulation properties with the use of mineral wool alone, as shown in FIG. 2 and discussed above. In such a use case, temperature insulation may be improved by approximately 8× at high temperatures (e.g., above 500° C.), and at 1-2× at lower temperatures (e.g., below 500° C.) while additionally having a weight that is half that of the mineral wool insulation shown in FIG. 2.

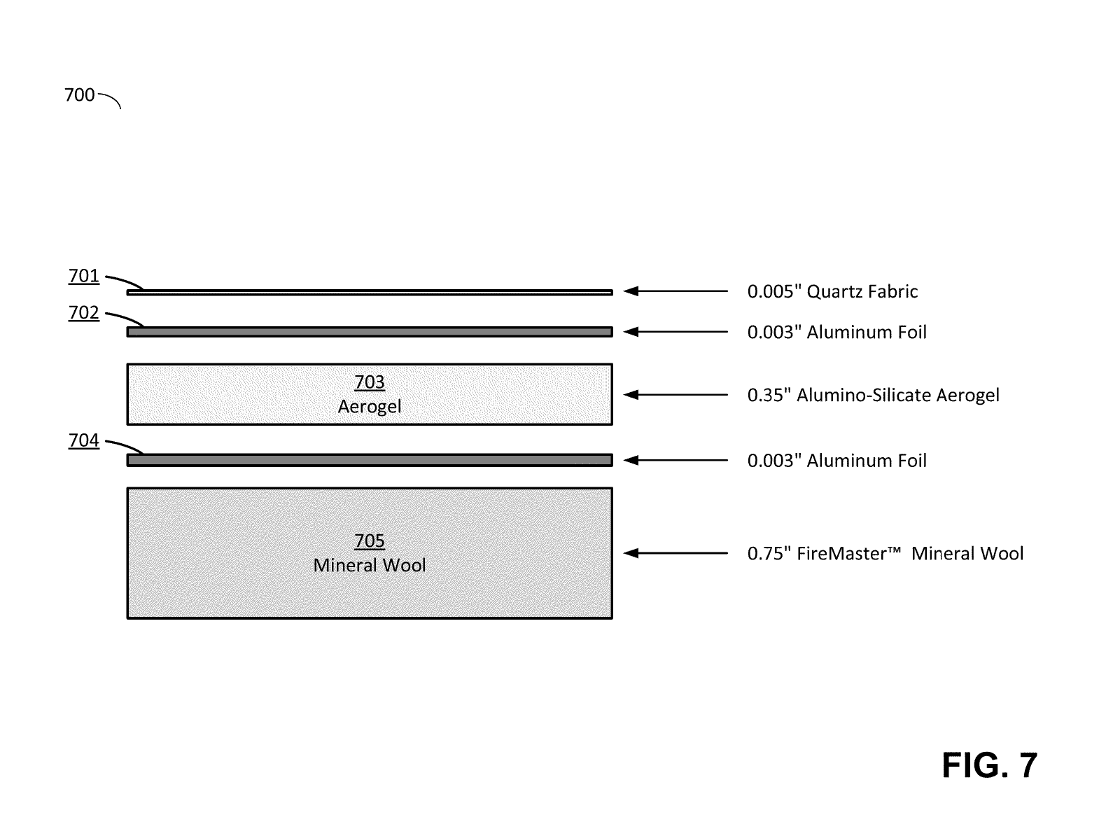

For example, a combination of a 0.35″ alumino-silicate aerogel fire facing layer and a 0.75″ mineral wool backing layer, with a quartz cloth containment layer and two aluminum foil reflecting layers was tested in a thickness that is expected to meet the MIL-STD-3020 fire resistance test in accordance with MIL-PRF-32161. This insulation was found to provide a 50% weight savings yet outperformed the insulation characteristics of the baseline mineral wool-only insulation. Such a weight advantage would result in a savings of many metric tons of weight for even a small naval vessel, providing an increase in performance and maneuverability. FIG. 7 depicts an exploded view of one illustrative fire insulation material having these characteristics. In the example of FIG. 7, fire insulation material 700 includes a fire facing containment layer 701 that consists of an inorganic cloth, a first reflector 702 consisting of aluminum foil, an alumino-silicate aerogel layer 703, the aerogel formed on an inorganic fiber substrate, a second reflector layer consisting of aluminum foil 704, and a layer of FireMaster™ Marino+mineral wool 705. Dimensions of each layer in the tested fire insulation material are shown in the figure, and are not drawn to scale. Further, it will be appreciated that FIG. 7 is provided merely as one illustrative example having particular dimensions, and that has been tested and found to have significant benefits over mineral wool-only insulation and aerogel-only insulation. Variations on this fire insulation materials, including those dimensions and layer combinations discussed above, may also provide such benefits.

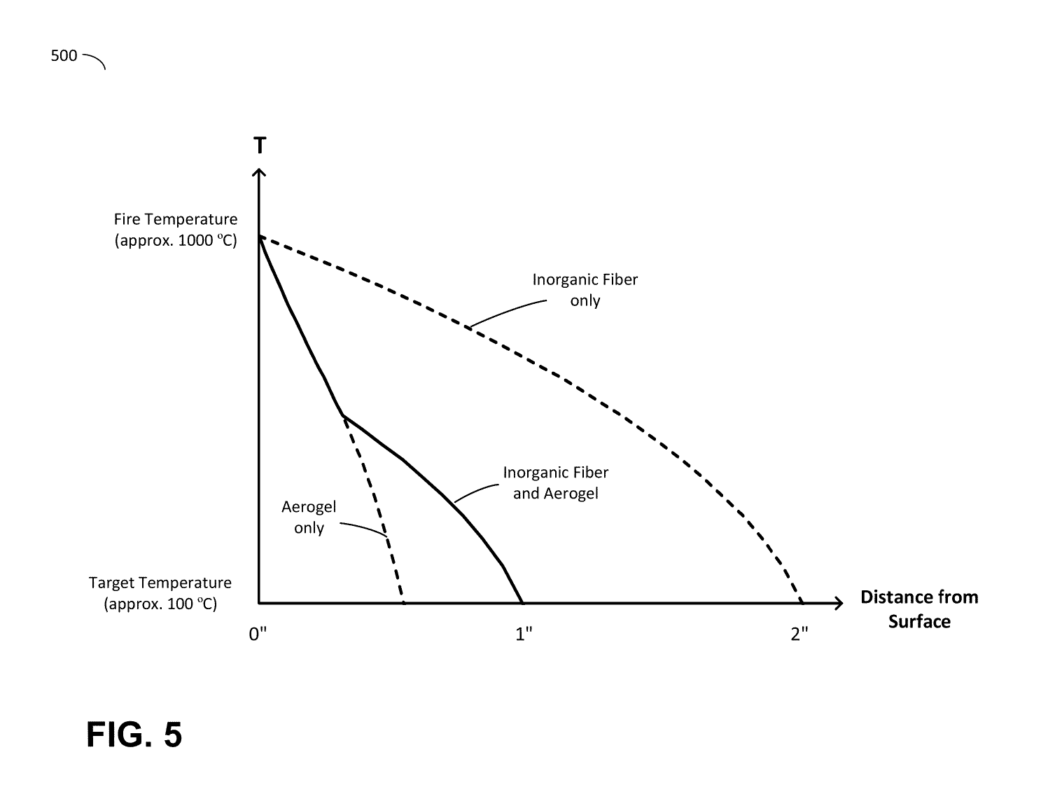

FIG. 5 depicts a graph of illustrative temperature gradients within an inorganic fiber, an aerogel, and an illustrative “combination” insulating material that includes a fire facing layer of an aerogel in addition to a layer of inorganic fiber (e.g., as shown in FIG. 4). As discussed above, while a combination insulating material may have a thickness that is much less than that of the inorganic fiber insulation, it may have a cost that is similar to that of the inorganic fiber but much less costly than the aerogel insulation while weighing substantially less than the inorganic fiber. FIG. 5 is provided merely to illustrate one possible temperature gradient that may be produced by combining an aerogel with an inorganic fiber, and should not be viewed as limiting the form of the temperature gradient that may be formed by arranging any number of layers of inorganic fiber, aerogel and/or other materials, in any suitable thicknesses, as discussed herein.

In the example of FIG. 5, an aerogel-only insulation provides suitable fire insulation to reduce temperatures from a fire temperature of approximately 1000° C. to a target temperature of approximately 100° C. over a thickness of approximately 0.6″. In contrast, an inorganic fiber insulation reduces temperatures from a fire temperature of approximately 1000° C. to a target temperature of approximately 100° C. over a thickness of approximately 2″. An combined inorganic fiber and aerogel insulation, however, reduces temperatures from a fire temperature of approximately 1000° C. to a target temperature of approximately 100° C. over a thickness of approximately 1″, which comprises a 0.3″ layer of aerogel and a 0.7″ layer of inorganic fiber, the aerogel layer being fire-facing.

Accordingly, the combined insulation may have a weight substantially less than that of the inorganic fiber only insulation, yet may cost a commensurate amount or may have a cost that represents only a modest increase over the inorganic fiber insulation (e.g., the cost of 0.3″ of aerogel and 0.7″ of inorganic fiber versus the cost of 2″ of inorganic fiber). In the case that the aerogel and inorganic fiber have comparable densities, the combined insulation may have a weight that represents 70% of the weight savings represented by the pure aerogel insulation over the inorganic fiber insulation, yet may have a substantially lower cost than the pure aerogel insulation.

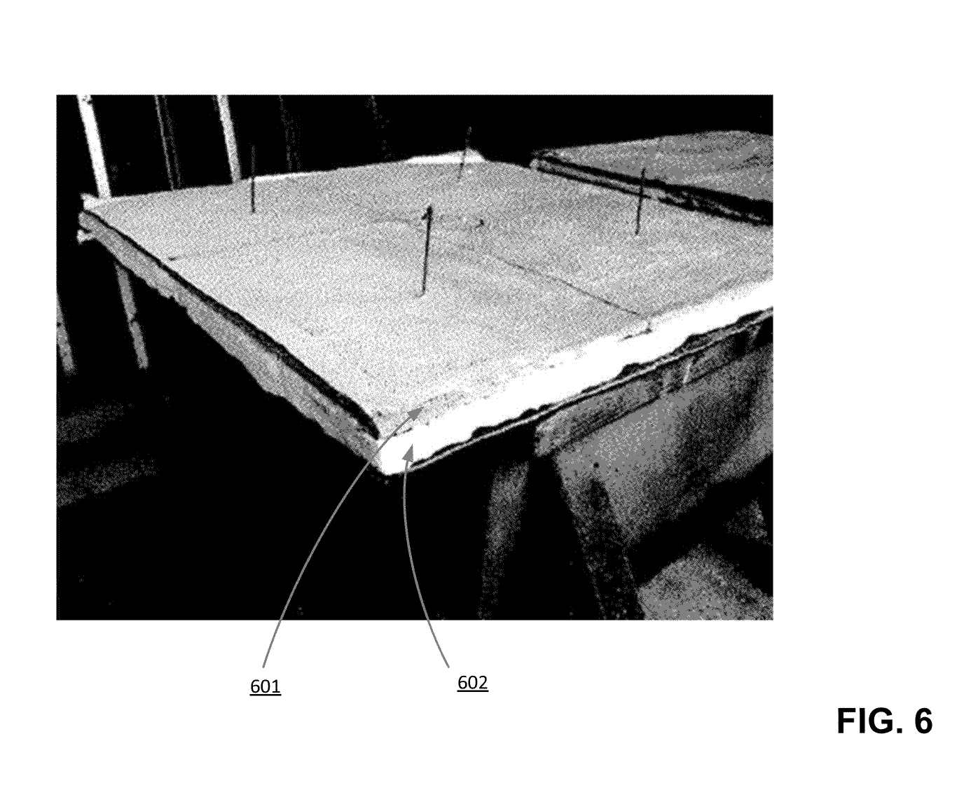

FIG. 6 is a photograph of a illustrative thermally-insulating blanket in accordance with some embodiments, showing an alumino-silicate aerogel layer 601 atop a mineral wool layer 602.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Further, though advantages of the present invention are indicated, it should be appreciated that not every embodiment of the invention will include every described advantage. Some embodiments may not implement any features described as advantageous herein and in some instances. Accordingly, the foregoing description and drawings are by way of example only.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments. In practice, any of the features in any of the above-mentioned alternative embodiments could be combined with any other feature to provide any desired combination of thermal insulation properties.

Also, the invention may be utilized in a suitable method, of which examples are discussed above. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A thermal insulation material, comprising:
a first insulation layer comprising an inorganic aerogel; and
a second insulation layer comprising inorganic fibers,
wherein a thickness of the second insulation layer is greater than a thickness of the first insulation layer.

2. The thermal insulation material of claim 1, further comprising a reflector layer between the first insulation layer and the second insulation layer.

3. The thermal insulation material of claim 2, wherein the reflector layer comprises aluminum foil.

4. The thermal insulation material of claim 1, wherein the thickness of the second insulation layer is at least twice the thickness of the first insulation layer and less than ten times the thickness of the first insulation layer.

5. The thermal insulation material of claim 1, wherein the inorganic fibers include a mineral wool.

6. The thermal insulation material of claim 1, wherein the thickness of the first insulation layer is less than 0.75″.

7. The thermal insulation material of claim 1, further including a dispersed radiant heat opacifier.

8. The thermal insulation material of claim 1, wherein the aerogel is a first aerogel, and further comprising a third insulation layer comprising a second aerogel, different from the first aerogel.

9. A thermal insulation material, comprising:
a first insulation layer comprising an alumino-silicate aerogel; and
a second insulation layer comprising inorganic fibers.

10. The thermal insulation material of claim 9, further comprising a reflector layer between the first insulation layer and the second insulation layer.

11. The thermal insulation material of claim 9, wherein the thickness of the second insulation layer is at least twice the thickness of the first insulation layer.

12. The thermal insulation material of claim 9, wherein the inorganic fibers include a mineral wool.

13. The thermal insulation material of claim 9, wherein the thickness of the first insulation layer is less than 0.75″.

14. A fire protection thermal insulation system comprising:
a first insulation layer comprising an aerogel, the first insulation layer on a fire facing side of the thermal insulation system; and
a second insulation layer comprising inorganic fibers, the second insulation layer on a non-fire facing side of the thermal insulation system,
wherein a thickness of the second insulation layer is greater than a thickness of the first insulation layer.

15. The fire protection thermal insulation system of claim 14, wherein the first insulation layer comprises an alumino-silicate aerogel and the inorganic fibers include a mineral wool.

16. The fire protection thermal insulation system of claim 14, wherein the thickness of the first insulation layer is less than 0.75″.

17. A method of providing fire insulation within an marine vessel, comprising:
attaching a thermal insulation material to one or more structures of the marine vessel, wherein the thermal insulation material comprises:
a first insulation layer comprising an aerogel, the first insulation layer on a side of the thermal insulation material distal to the one or more structures; and
a second insulation layer comprising inorganic fibers, the second insulation layer on a side of the thermal insulation material proximal to the one or more structures,
wherein a thickness of the second insulation layer is greater than a thickness of the first insulation layer.

18. The method of claim 19, wherein the first insulation layer comprises an alumino-silicate aerogel.

19. The method of claim 19, wherein a thickness of the thermal insulation material is less than 2″.

20. The method of claim 19, wherein the thermal insulation material further comprises a reflector layer between the first insulation layer and the second insulation layer.
